(19) United States
(12) Patent Application Publication
(10) Pub. No.: US 2004/0209129 A1
(43) Pub. Date: Oct. 21, 2004

(54) Combustion process, in particular for a process for generating electrical current and/or heat

(76) Inventor: Elisabetta Carrea, Zuerich (CH)

Correspondence Address: CERMAK & KENEALY LLP, P.O. BOX 7518, ALEXANDRIA, VA, 22307, US

(21) Appl. No.: 10/814,167

(22) Filed: Apr. 1, 2004

Related U.S. Application Data
(63) Continuation of application No. PCT/IB02/04014, filed on Sep. 30, 2002.

(30) Foreign Application Priority Data
Oct. 1, 2001 (CH) 2001 1808/01

(51) Int. Cl. H01M 8/00; H01M 8/04; H01M 8/18

(52) U.S. Cl. 429/13; 429/17; 429/19

(57) ABSTRACT

The invention relates to a process, in particular for a process for generating electrical power and/or heat, in which a gas mixture is formed from oxygen, fuel and substantially nitrogen-free inert gas and is burnt in a burner (3). In order to ensure stable combustion even in the case of a relatively high amount of inert gas, the combustion is embodied as flameless combustion.

This application is a Continuation of and claims priority under 35 U.S.C. § 120 to International application no. PCT/IB02/04014, filed 30 Sep. 2002, and claims priority under 35 U.S.C. § 119 to Swiss patent application no. 2001 1808/01, filed 01 Oct. 2001, the entireties of both of which are incorporated by reference herein.

### TECHNICAL FIELD

The invention relates to a combustion process, in particular for a process for generating electrical current and/or heat, having the features of the preamble to claim 1. The invention additionally relates to a combustion process, which operates with flameless combustion, having the features of the preamble to claim 2. In addition, the invention relates to an installation, in particular a gas turbine installation, for carrying out such combustion processes, and to a particular use of a combustion process operating with flameless combustion.

### PRIOR ART

A combustion process for a process for generating electrical current and/or heat is known from WO 98/55208, in which process a gas mixture consisting of oxygen, fuel and substantially nitrogen-free inert gas is formed and burnt in a burner. In this process, the inert gas is formed by the combustion exhaust gases of the burner, it being possible for quite negligible parasitic nitrogen proportions due to the fuel burnt to be contained in this intrinsically nitrogen-free exhaust gas. In this process, the oxygen for the gas mixture is made available by means of an oxygen transport membrane, to a retentate side of which air, preferably heated and compressed, is admitted. This membrane extracts oxygen from the air present on its retentate side, transports the oxygen to a permeate side of the membrane and releases it there.

The oxygen on the permeate side can be transported away by means of a scavenging gas. The burner combustion exhaust gas, which can be additionally heated by combustion with fuel, is expediently used as the scavenging gas. Certain embodiments of such membranes are known as MCM (mixed conducting membrane).

No nitrogen—apart from parasitic nitrogen constituents in the fuel—takes part in such a combustion process so that the resulting exhaust gases substantially contain only CO₂ and H₂O in the form of water vapor. The CO₂ can be separated and disposed of relatively easily by condensing out the water vapor. Because, fundamentally, no damaging emissions occur in such a combustion process, it is therefore also possible to refer to a zero emission process in this case.

A relatively high scavenging gas volume flow is necessary to increase the output capability of an oxygen transport membrane. In the case of these advantageously large scavenging gas quantities, however, the result is an exhaust gas/oxygen mixture whose oxygen proportion is so small that it is only very weakly reactive. Conventional combustion processes, in particular combustion processes operating with diffusion flame, can no longer be used. As an example, the gas mixture consisting of oxygen diluted with scavenging gas and added fuel can be composed as follows in terms of its volume—2.5% CH₄, 5% O₂, 27.5% CO₂, 65% H₂O. The temperature of this gas mixture is usually between 600 and 900° C. A reactivity resulting under these conditions, in the case of existing weak premixing burners and catalytic burners, is smaller than in the case of otherwise usual fuel/air mixtures at the same temperatures. This produces high ignition delay times, a reduced flame speed and relatively tight weak extinguishing limits. In addition, the operating parameters are also impaired by the fact that the obtainable temperature of the combustion gases is distinctly reduced and is located, for example, at only some 1200° C. Because of these conditions, conventional combustion processes cannot be used in a satisfactory manner to produce stable combustion of such a weakly reactive gas mixture.

When a burner is integrated into a heat exchanger and/or into an oxygen separating device operated with an oxygen transport membrane or if the burner feeds its combustion exhaust gases directly into a heat exchanger or such an oxygen separating device, further problems occur. This is because the operation of such heat exchangers and/or oxygen separating devices is only optimal with respect to heat transfer and thermal load if a temperature distribution is achieved which is as uniform as possible. In the case of conventional combustion processes, however, there are usually non-uniform temperature distributions.

A method for burning fuel in a combustion space is known from EP 0 463 218 A1, in which fuel is oxidized with preferably preheated combustion air in the presence of recirculated combustion exhaust gases. In the case of air combustion, thermal NOₓ is always formed, the NOₓ formation increasing strongly with increasing flame temperature. In order to reduce the NOₓ emissions, the known process proposes oxidizing the fuel, substantially flamelessly and pulsation-free, with an extremely high level of combustion exhaust gas recirculation system. This is achieved by combustion exhaust gases, from which useful heat has been previously removed to outside the system, being mixed with the preheated combustion air in a combustion exhaust gas recirculation system ratio greater than or equal to 2. In this arrangement, the exhaust gas recirculation system ratio is defined as the ratio between the mass flows of the recirculated combustion exhaust gas and the combustion air supplied, this exhaust gas/air mixture being kept at a temperature which is higher than the ignition temperature, and the exhaust gas/air mixture being then brought together with the fuel so as to form an oxidation zone in which a substantially flameless and pulsation-free oxidation takes place in the combustion space. By means of this known process, the NOₓ emissions in the case of combustion using air can be reduced by an estimated factor of 10.

### PRESENTATION OF THE INVENTION

The present invention deals with the problem of indicating satisfactorily functional possibilities for the combustion of weakly reactive and nitrogen-free gas mixtures.

This problem is solved by means of the subject matters of the independent claims. Advantageous embodiments are given in the dependent claims.

The invention is based on the general idea of using the flameless combustion, which is known for the reduction of NOₓ emissions, for the combustion of a nitrogen-free gas mixture. It may be easily recognized that the use of a method operating with flameless combustion and recognized for the reduction of the NOₓ emissions apparently takes place without motive in the case of a nitrogen-free combustion process, which therefore operates without NOₓ emissions, because the combustion process operating nitrogen-free cannot be improved with respect to its NOₓ emission figures. The invention uses the knowledge that a combustion method operating with flameless combustion is suitable, in a particular manner, for the combustion of weakly reactive gas mixtures. Where a weakly reactive gas mixture is to be burnt, in particular where the oxygen of the gas mixture to be burnt is obtained by means of an oxygen transport membrane with rather large scavenging gas quantity, the output capability of the combustion process operating nitrogen-free can be distinctly improved by the combination, according to the invention, of a combustion process operating nitrogen-free with a flamelessly operating combustion process. A synergic effect is achieved by means of the invention. Such an effect is not to be expected because the known combustion process operating with flameless combustion is used expressly for the reduction of the NOₓ emissions. These, however, do not exist at all in the case of a combustion process operating nitrogen-free and on which the invention is based. To this extent, the present invention uses the combustion process operating with flameless combustion for a different purpose. This is because the use of the flameless combustion in a combustion process operating nitrogen-free permits reliable and stable combustion of a weakly reactive gas mixture.

Further important features and advantages of the invention follow from the subclaims, the drawings and the associated description of the figures, using the drawings.

### BRIEF DESCRIPTION OF THE DRAWINGS

Preferred exemplary embodiments of the invention are represented in the drawings and are explained in more detail in the following description, in which the same designations refer to identical or functionally identical or similar features. In the drawings, diagrammatically in each case:

FIG. 1 shows, in principle, a greatly simplified representation of an appliance according to the invention,

FIG. 2 shows, in principle, a greatly simplified representation of a burner for an appliance as shown in FIG. 1, and

FIG. 3 shows a view like that of FIG. 2, but for another embodiment.

### WAYS OF CARRYING OUT THE INVENTION

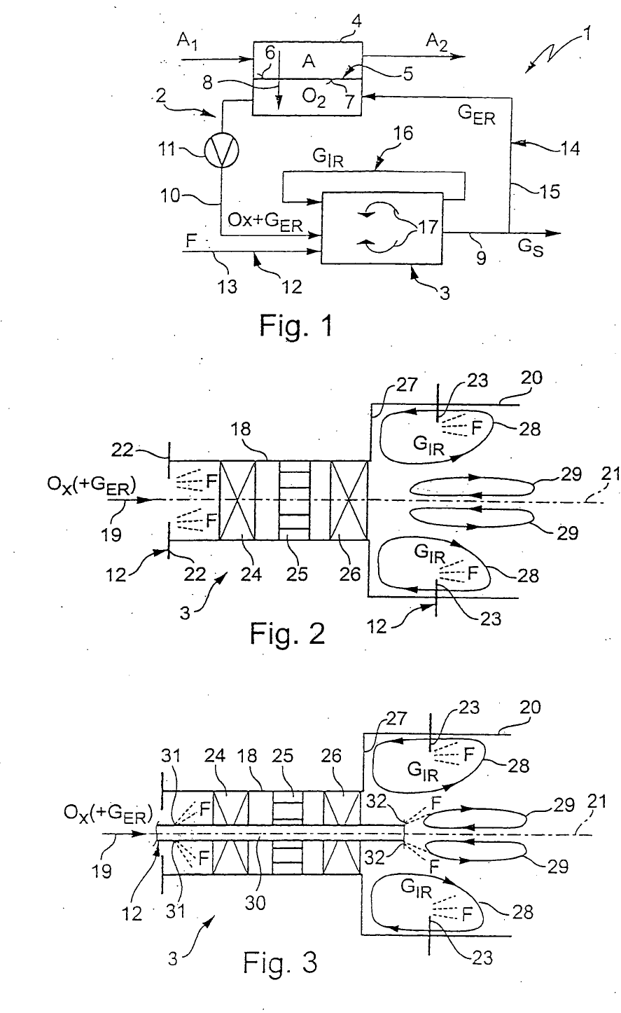

As shown in FIG. 1, an appliance or installation 1 according to the invention includes a mixture forming device 2 and a burner 3. The mixture forming device 2 comprises an oxygen separating device 4, which is equipped with an oxygen transport membrane 5. As shown in FIG. 1, the membrane 5 includes a retentate side 6 at the top and, as shown in FIG. 1, a permeate side 7 at the bottom. On the retentate side 6, the membrane 5 is supplied with an oxygen-containing gas A₁, for example air. At the membrane 5, as shown by an arrow 8, a transport then takes place of oxygen (O₂), which is extracted from the retentate side 6 of the membrane 5 and transported to its permeate side 7. In the oxygen separating device 4, the oxygen content of the gas A₁ supplied to the retentate side 6 is, in consequence, reduced; the gas located in the oxygen separating device 4 is correspondingly designated by A in FIG. 1. Gas A₂, which has been reduced in terms of its oxygen content, then emerges from the oxygen separating device 4.

In order to increase the output capability of the membrane 5, an inert scavenging gas G_{ER} is admitted to its permeate side 7 and this scavenging gas G_{ER} transports the oxygen out of the oxygen separating device 4. In the present case, the scavenging gas G_{ER} is formed by externally recirculated exhaust gas, which is extracted from an exhaust gas pipework train 9 after the burner 3.

The oxygen separating device 4 can, in addition, be expediently configured as a heat exchanger. In this way, the temperature of the oxygen-containing gas A₁ supplied can be increased in order to improve the output capability of the oxygen separating device 4.

The externally recirculated exhaust gas, which has been enriched with oxygen, is supplied to the burner 3 via a conduit 10. A pump 11 or turbine or fan or the like can be arranged in the conduit 10 to propel this gas mixture of oxygen and externally recirculated exhaust gas.

A fuel injection device 12, which can form a constituent part of both the mixture forming device 2 and the burner 3, is also provided. In the present case, a fuel conduit 13 guides fuel F to the burner 3. As already mentioned above, the burner 3 is equipped with an external exhaust gas recirculation system system 14 which, by means of a recirculation conduit 15 branching off from the exhaust gas pipework train 9, extracts a part of the combustion exhaust gases after the burner 3 and finally mixes it in again before the burner 3. In the case shown here, the externally recirculated exhaust gases G_{ER} are used for scavenging the membrane 5. In this arrangement, the burner 3 is, furthermore, equipped with an internal exhaust gas recirculation system system 16, in which a part of the exhaust gases remains in a combustion space (not shown in FIG. 1) of the burner 3. These internally recirculated exhaust gases, which are designated by G_{ER}, are mixed in the combustion space with the other gas components supplied to the burner 3 in order, by this means, to form the desired gas mixture, which has a relatively high exhaust gas recirculation system rate (external and/or internal). The internal exhaust gas recirculation system system is, furthermore, symbolized by arrows 17 in FIG. 1.

As may be seen from the diagram shown in FIG. 1, the combustion process which can be carried out using the installation 1 operates without nitrogen so that the combustion exhaust gases generated by the burner 3 contain no NOₓ proportions or only parasitic NOₓ proportions derived from the fuel. The resulting exhaust gas G_{S} contains, essentially, only CO₂ and water vapor (H₂O).

According to the invention, the burner 3 is configured for carrying out a flameless combustion. For this purpose, the mixture forming device 2 is designed in such a way that, in order to produce the gas mixture to be burnt, it is only in the burner 3 that it brings together the oxidant Oₓ with the externally recirculated exhaust gases G_{ER} and the fuel F. In addition, a corresponding interaction between the mixture forming device 2 and the burner 3 ensures that the finished gas mixture—which, in the embodiment shown in FIG. 1, is formed first by the mixing of the internally recirculated exhaust gas quantity G_{IR},—has a temperature which is above the self-ignition temperature of this gas mixture. Under these conditions, the desired flameless combustion can be realized in the burner 3. A particular advantage of the arrangement is that such a flameless combustion can still take place with sufficient stability when the gas mixture to be burnt has a very low oxygen content, i.e. a very weak reactivity. This is, in particular, the case when a relatively large scavenging gas quantity is used to transport away the oxygen in order to improve the output capability of the oxygen separating device 4, i.e. a relatively high external exhaust gas recirculation system rate is used. In this case, it is quite possible for the external exhaust gas recirculation system rate to be chosen to be so large that it is possible to dispense with an internal exhaust gas recirculation system to a greater or lesser extent or for the internal exhaust gas recirculation system to be kept very small.

It has been found that reliable flameless combustion can be realized if, in the gas mixture, a volume ratio—of inert gas (i.e. externally recirculated exhaust gas G_{ER} and internally recirculated exhaust gas G_{IR}) to fuel F and oxygen Oₓ—is greater than 2, in particular greater than 3.

Corresponding to FIG. 2 and a special embodiment, the burner 3 can have a precombustion space 18 and a main combustion space 20, which is arranged downstream with respect to a through-flow direction of the burner 3 symbolized by an arrow 19. The burner 3 has, expediently, an axisymmetrical configuration with respect to an axis of symmetry 21.

In the embodiment shown in FIG. 2, the fuel injection device 12 is designed in such a way that first injection nozzles 22 permit a pre-injection of fuel in the precombustion space 18. In addition, second injection nozzles 23 are provided which permit a main injection of fuel in the main combustion space 20. A mixing device 24, a catalyzer device 25 and a swirler device 26 are arranged in sequence in the flow direction 19 in the precombustion space 18.

The burner 3 shown in FIG. 2 operates as follows:

Oxygen Oₓ is supplied to the precombustion space 18, which oxygen Oₓ can be diluted to a greater or lesser extent by externally recirculated exhaust gas G_{ER} so that an oxygen/exhaust gas mixture Oₓ+G_{ER} is supplied. A relatively small fuel quantity is injected via the first injection nozzles 22. An intensive mixing of the individual components takes place in the mixing device 24. A catalytically initiated or stabilized combustion of the fuel F, with only a part of the oxygen quantity supplied being consumed, takes place in the catalyzer device 25, which contains a corresponding catalyzer. It is, in particular, possible to conduct only part of the flow through the catalyzer device 25. This permits complete combustion of the oxygen also to be realized in this partial flow.

An increase in temperature in the gas mixture supplied to the main combustion space 20 can be achieved by means of the catalytic combustion. Due to the catalytic combustion in the precombustion space 18, the exhaust gas quantity and therefore the exhaust gas concentration can be increased quasi-internally, which permits the recirculated exhaust gas quantity G_{ER} to be reduced. Because a high external exhaust gas recirculation system rate leads to high pressure losses, for which compensation must be provided by corresponding pumping power, the overall efficiency of the turbine process can be improved by the internal catalytic exhaust gas generation proposed here.

During the flow through the swirler device 26, a desired flow behavior and/or vortex behavior can be imposed on the gas flow. The supply of further fuel F then takes place in the main combustion space 20 via the second injection nozzles 23, the desired gas mixture with a temperature located above the self-ignition temperature of this gas mixture then being formed. Depending on the external exhaust gas recirculation system rate, an internal exhaust gas recirculation system can be necessary for this mixture formation. This internal exhaust gas recirculation system can, in this case, be generated by means of appropriate, aerodynamically operating exhaust gas conduction devices. In the embodiment example represented, such an exhaust gas conduction device is formed by a cross-sectional expansion 27 at the transition from the precombustion space 18 to the main combustion space 20; this cross-sectional expansion 27 initiates an annular vortex recirculation symbolized by an arrow 28. The exhaust gas conduction device formed in this way effects, by means of the vortex 28, a reverse flow of a part of the exhaust gases against the through-flow direction 19 of the burner 3, so that this proportion of the exhaust gases remains in the main combustion space 20. The annular vortex recirculation represented in the vicinity of the axis of symmetry 21 and designated by 29 can, for example, be initiated by the swirler device 26, in particular in association with the cross-sectional expansion 27. This vortex recirculation 29 also supports the internal exhaust gas recirculation system.

Relatively large residence times for the gas to be burnt in the burner 3 can be achieved by an appropriate selection of the flow velocities, the swirl arrangements and, in particular, the internal exhaust gas recirculation system, by which means complete combustion of the injected fuel can be ensured.

This recirculation, on the basis of the vortices 28 and 29, also supports the mixing of the internally recirculated exhaust gases with the gas mixture introduced into the main combustion space 20. By this means, heating of the combustible mixture and a stabilization of the reactions can, for example, also be achieved. Correspondingly, the catalyzer device 25, which leads to an increase of temperature in the mixture, is not absolutely necessary but it can, however, be helpful in the part-load range.

As shown in FIG. 3, in the case of a particular embodiment, the fuel injection device 12 can have a lance 30, which extends coaxially with the axis of symmetry 21. This lance 30 includes first injection nozzles 31 associated with the precombustion space 18 and second injection nozzles 32 associated with the main combustion space 20. A particularly homogeneous distribution of the fuel quantity injected can be achieved in the main combustion space 20 by means of such a lance 30 and, by this means, the formation of a flameless combustion is facilitated.

It is clear that the injection nozzles 22, 23, 31 and 32 are advantageously arranged with an axisymmetrical distribution relative to the axis of symmetry 21, it being quite possible to provide, of each nozzle type, more than the two nozzles represented as an example.

Due to the flameless combustion in the main combustion space 20, there is a homogeneously distributed combustion process over the whole of the main combustion space 20 and this takes place without pulsations. The flameless combustion therefore generates a homogeneous temperature distribution over the whole of the main combustion space 20, which substantially simplifies the integration of the burner 3 into a heat exchanger and/or into an oxygen separating device 4 and substantially simplifies a direct attachment of the burner 3 to a heat exchanger and/or to an oxygen separating device 4.

The danger of flashback is reduced because, in the case of the flameless combustion, an individual ignition point can no longer be localized within the combustion space.

Whereas, in the embodiments shown in FIGS. 1 to 3, it is always pure fuel which is introduced into the burner 3 and/or into the main combustion space 20, a mixture of fuel and inert gas, for example externally recirculated exhaust gas, can also be used in another embodiment to configure the desired gas mixture. As a departure from the embodiments shown, it is likewise possible to supply the oxygen substantially in pure form to the burner 3 and/or to the main combustion space 20 instead of supplying a mixture of oxygen and inert gas. Substantially pure oxygen can, for example, be produced by cryotechnical means.

In an embodiment in which the mixture forming device 2 introduces substantially pure oxygen into the main combustion space 20, this takes place in order to achieve the desired gas mixture at a location near which the fuel injection also takes place. An internal exhaust gas recirculation system with a relatively high recirculation rate is then used to configure the desired gas mixture.

Where pure oxygen is available and is introduced into the main combustion space 20 near the fuel injection, the flameless combustion reaction can be initiated relatively stably because of the locally increased temperatures. In such an embodiment, it is therefore possible to dispense with the catalyzer device 25.

It is likewise possible to introduce oxygen into both the precombustion space 18 and the main combustion space 20. By this means, a catalytic preheating of the gas mixture supplied can be achieved, on the one hand, and relatively stable flameless combustion can be realized, on the other. The last-mentioned embodiment is advantageous, particularly at part load of the burner 3.

It is clear that the exhaust gases Gs generated by the burner 3 can, for example, be used in a gas turbine installation for the generation of electrical energy.

List of designations

1 Installation

2 Mixture forming device

3 Burner

4 Oxygen separating device

5 Oxygen transport membrane

6 Retentate side of 5

7 Permeate side of 5

8 Oxygen transport

9 Exhaust gas pipework train

10 Conduit

11 Pump

12 Fuel injection device

13 Fuel conduit

14 External exhaust gas recirculation system

15 Recirculation conduit

16 Internal exhaust gas recirculation system

17 Arrow

18 Precombustion space

19 Flow direction

20 Main combustion space

21 Axis of symmetry

22 First injection nozzle

23 Second injection nozzle

24 Mixing device

25 Catalyzer device

26 Swirler device

27 Cross-sectional expansion

28 Vortex recirculation

29 Vortex recirculation

30 Lance

31 First injection nozzle

32 Second injection nozzle

1. A combustion process comprising:
forming a gas mixture from oxident, fuel, and inert gas; and
combusting said gas mixture in a burner, wherein combusting comprises flameless combustion.

2. The process as claimed in claim 1,
wherein said oxidant comprises substantially pure oxygen or a mixture of substantially pure oxygen and substantially nitrogen-free inert gas; and
wherein said inert gas comprises a substantially nitrogen-free inert gas.

3. The process as claimed in claim 1, wherein the temperature of the gas mixture is above the self-ignition temperature of the gas mixture, and further comprising:
forming an admixture in said burner, before said combusting, of:
oxygen, or a mixture of oxygen and inert gas;
fuel, or a mixture of fuel and inert gas;
or both.

4. The process as claimed in claim 1, wherein the inert gas comprises a mixture of inert gases.

5. The process as claimed in claim 1, wherein, in the gas mixture, the volume ratio of inert gas to fuel and oxygen is greater than 1.5.

6. The method as claimed in claim 1, further comprising:
forming the inert gas from an exhaust gas occurring during combusting of the gas mixture.

7. The method as claimed in claim 6, comprising:
admixing exhaust gas to oxygen, to fuel, or both,
with an internal exhaust gas recirculation system by retaining a part of the exhaust gases in a combustion space of the burner,
with an external exhaust gas recirculation system by extracting a part of the exhaust gases after the burner and recirculating said part of the exhaust gases to before the burner, or
both.

8. The method as claimed in claim 1, wherein forming comprises forming with cryotechnically produced, substantially pure oxygen.

9. The method as claimed in claim 1, wherein forming comprises:
forming with a mixture of substantially pure oxygen and inert gas, including extracting oxygen with an oxygen transport membrane from an oxygen-containing gas mixture arranged on a retentate side of the membrane, and transporting said extracted oxygen to a permeate side of the membrane, and removing said transported oxygen by scavenging with the inert gas.

10. The method as claimed in claim 1, wherein forming the gas mixture comprises mixing the fuel or a mixture of fuel and inert gas at least at two locations in the burner arranged sequentially relative to a through-flow direction of the burner.

11. The method as claimed in claim 1, further comprising:
precombusting a partial quantity of the oxygen and a partial quantity of the fuel to increase the mixture temperature in the burner, to increase the exhaust gas proportion in the gas mixture before a main combustion space, or both, said precombusting being catalytically initiated, stabilized, or both.

12. An installation useful for carrying out a process as claimed in claim 1, comprising:
a mixture forming device configured and arranged for the formation of a substantially nitrogen-free gas mixture of oxidant, fuel, and inert gas, and having a burner configured and arranged for carrying out flameless combustion, the mixture forming device configured and arranged to bring oxygen and fuel together in the burner first to form a gas mixture having a temperature above the self-ignition temperature of said gas mixture.

13. The installation as claimed in claim 12, further comprising:
an exhaust gas recirculation system; and
wherein the inert gas is formed by the exhaust gas resulting during the combustion of the gas mixture.

14. The installation as claimed in claim 13, wherein the burner comprises a combustion space, and wherein the exhaust gas recirculation system comprises:
an internal exhaust gas recirculation system configured and arranged to retain a part of the exhaust gases in the combustion space of the burner;
an external exhaust gas recirculation system configured and arranged to extract a part of the exhaust gases after the burner and to recirculate said extracted part of the exhaust gases to before the burner; or
both.

15. The installation as claimed in claim 14, wherein the internal exhaust gas recirculation system includes a swirler device configured and arranged to swirl a gas flow of oxygen or a mixture of oxygen and exhaust gas before, or at an entry into, a combustion space of the burner.

16. The installation as claimed in claim 14, wherein the internal exhaust gas recirculation system comprises, in a combustion space of the burner, an exhaust gas guidance device configured and arranged to effect or support a reverse flow of a part of the exhaust gases within the combustion space against the through-flow direction of the burner.

17. The installation as claimed in claim 12, wherein the burner comprises an upstream precombustion space and a downstream main combustion space, and further comprising:
a fuel injection device configured and arranged to introduce fuel both in the burner upstream precombustion space and in the burner downstream main combustion space.

18. The installation as claimed in claim 17, wherein the fuel injection device comprises a lance extending centrally in the burner upstream precombustion space and in the burner downstream main combustion space, and has upstream injection nozzles associated with the burner upstream precombustion space and downstream injection nozzles associated with the burner downstream main combustion space, wherein said burner upstream and downstream injection nozzles are configured and arranged to introduce fuel into the burner upstream precombustion space and into the burner downstream main combustion space, respectively.

19. The installation as claimed in claim 17, further comprising:
a catalyzer arranged in the burner upstream precombustion space, said catalyzer configured and arranged to at least partially burn fuel and oxygen when introduced into the burner upstream precombustion space.

20. The installation as claimed in claim 12, wherein the mixture forming device includes an oxygen separating device with an oxygen transport membrane, the membrane including a retentate side and a permeate side, the membrane configured and arranged to extract oxygen from an oxygen-containing gas mixture when arranged on the retentate side of the membrane and to transport said oxygen to the permeate side of the membrane, and further comprising:
a scavenging gas comprising exhaust gas positioned to scavenge said transported oxygen.

21. The installation as claimed in claim 12, wherein the burner comprises a combustion space, and wherein the mixture forming device is configured and arranged to introduce substantially pure oxygen into the burner combustion space near a location at which fuel or a mixture of fuel and inert gas is introduced into the combustion space, and further comprising:
an internal exhaust gas recirculation system configured and arranged to retain a part of exhaust gases in the combustion space and to supply the retained exhaust gases as inert gas lacking for the formation of the gas mixture.

22. The process as claimed in claim 1, wherein the combustion process comprises a combustion process for generating electrical current, heat or both.

23. The process as claimed in claim 1, wherein combusting consists essentially of flameless combusting.

24. The process as claimed in claim 5, wherein the volume ratio of inert gas to fuel and oxygen is about 2.5.

25. A system comprising:
a gas turbine installation comprising an installation according to claim 12.

26. An installation as claimed in claim 16, wherein the exhaust gas guidance device comprises a cross-sectional expansion.

27. An installation as claimed in claim 19, further comprising:
a catalyzing device comprising said catalyzer.

28. An installation as claimed in claim 20, further comprising:
an external exhaust gas recirculation system configured and arranged to deliver said exhaust gas to said membrane.
